(19) United States
(12) Patent Application Publication
(10) Pub. No.: US 2010/0274821 A1
(43) Pub. Date: Oct. 28, 2010

(54) Schema Matching Using Clicklogs

(75) Inventors: Philip A. Bernstein, Bellevue, WA (US); Arnab Nandi, Ann Arbor, MI (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/428,271

(22) Filed: Apr. 22, 2009

(51) Int. Cl. G06F 17/30

(52) U.S. Cl. 707/808; 707/E17.017; 707/E17.044

(57) ABSTRACT

Techniques described herein describe a schema and taxonomy matching process that uses clicklogs to map a schema for source data to a schema for target data. A search engine may receive source data that is structured using the source schema, and the search engine itself may contain target data structured using the target schema. Using query distributions derived from the clicklogs, the source schema may be mapped to the target schema. The mapping can be used to integrate the source data into the target data and to index the integrated data for a search engine.

### BACKGROUND

A search engine is a tool designed to search for information on the World Wide Web (WWW), where the information may include web pages, images, information and/or other types of files. A search engine may incorporate various collections of structured data from various sources into its search mechanism. For example, a search engine may combine multiple databases and document collections with an existing warehouse of target data to provide a unified search interface to a user.

### SUMMARY

Techniques described herein describe a schema and taxonomy matching (also referred to as “mapping”) process that uses click-through query logs (“clicklogs”). A search engine module (e.g., an integration framework module) may receive source data that is structured using source taxonomies and/or source schema. The search engine itself contains target data that is structured using different taxonomies and/or schema (e.g., target taxonomies and/or target schema). The search engine module may map and integrate the source data into the target data by converting the source data structured by the source taxonomy and/or source schema into being structured by the target taxonomy and/or target schema. As a result, the search engine may be able to access and search the new integrated data.

The search engine module may access historical data in the query clicklogs to calculate a frequency of the distribution of elements in the source schema/taxonomy, as well as for elements in the target schema/taxonomy. Specifically, the frequency distribution may indicate the number of times a set of keywords leads to a click on a URL (hence the click-through description) that corresponds to an element of the source or target schema, respectively.

The search engine module may then group the frequency distribution for the source and target schema/taxonomy by grouping URLs that represent instances of schema elements. This grouping may generate a distribution of keyword queries and their associated frequencies for each element for the source and target schema/taxonomy. The mapping process generates one or more correspondences for each element from the source schema that is similar to an element in the target schema if their query distributions are similar. Using these one or more correspondences, the source data may be integrated into the target data. As a result, the search engine may use the integrated source data for generating query results.

Furthermore, for source data that does not have a well-established click-through query log history, the search engine module may use a surrogate source data for a surrogate query clicklog to calculate the frequency distribution for the source data. For example, a data set for similar products may be used as a surrogate source data.

In addition, this method may be used in matching taxonomies by converting members of source data and/or target data from being categorized using taxonomies to being categorized using schema. Specifically, the method may pivot the source data on the taxonomy terms so that each taxonomy term becomes a schema element, thus reducing a taxonomy matching problem to a schema matching problem.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “tools,” for instance, may refer to system(s), method(s), computer-readable instructions, and/or technique(s) as permitted by the context above and throughout the document.

### BRIEF DESCRIPTION OF THE CONTENTS

The detailed description is described with reference to accompanying FIGs. In the FIGs, the left-most digit(s) of a reference number identifies the FIG. in which the reference number first appears. The use of the same reference numbers in different FIGs indicates similar or identical items.

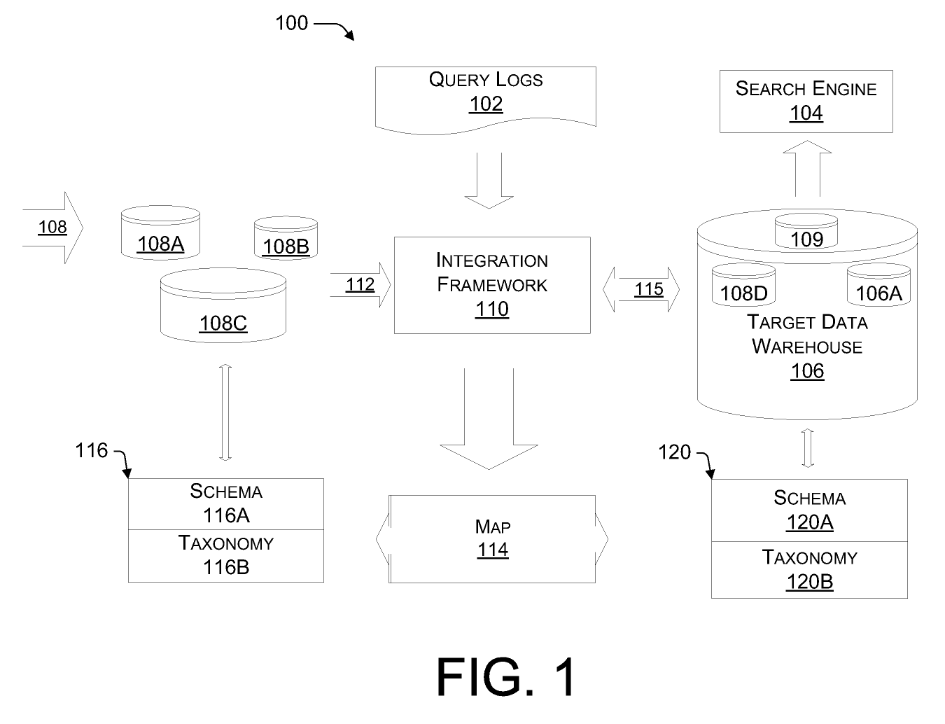

FIG. 1 illustrates an illustrative framework for a schema and taxonomy matching system, according to certain embodiments.

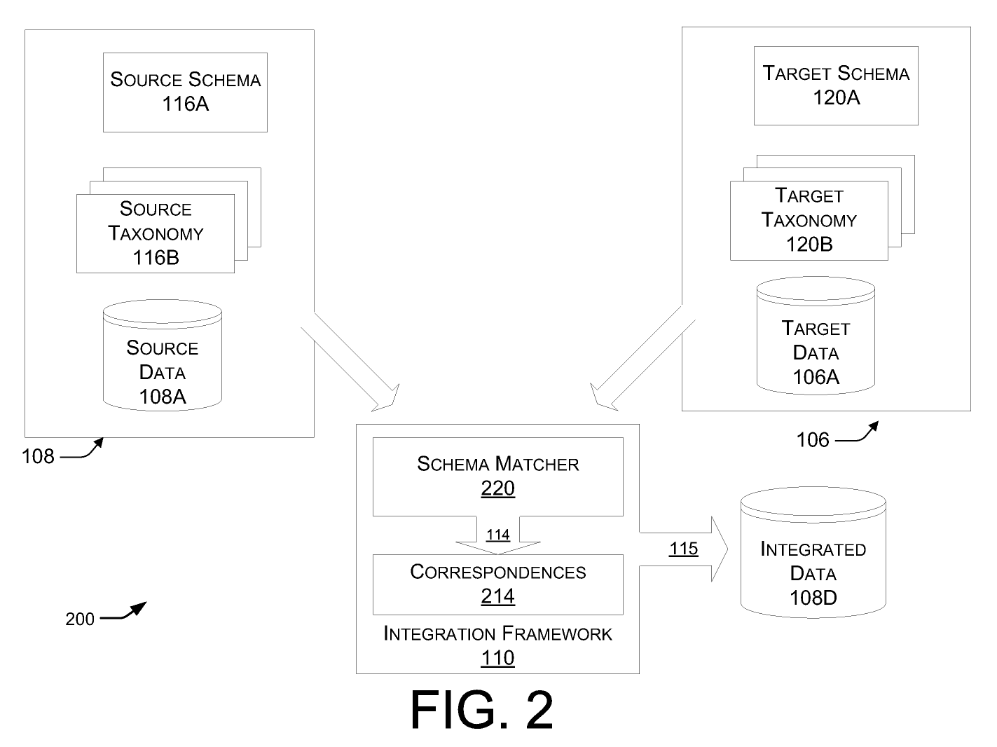

FIG. 2 also illustrates an illustrative framework for the schema and taxonomy matching system, according to certain embodiments.

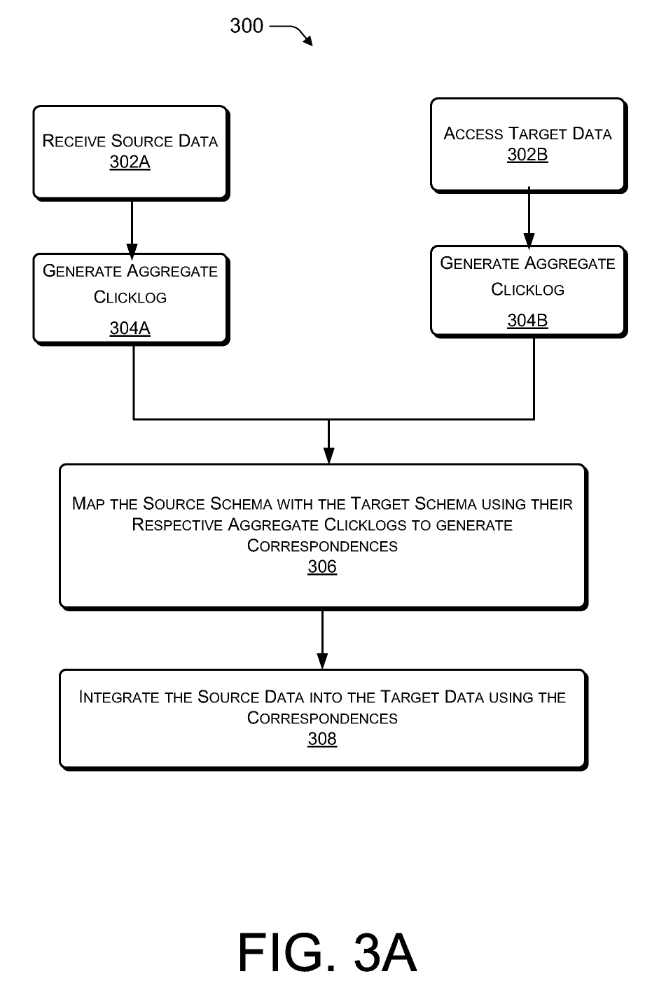

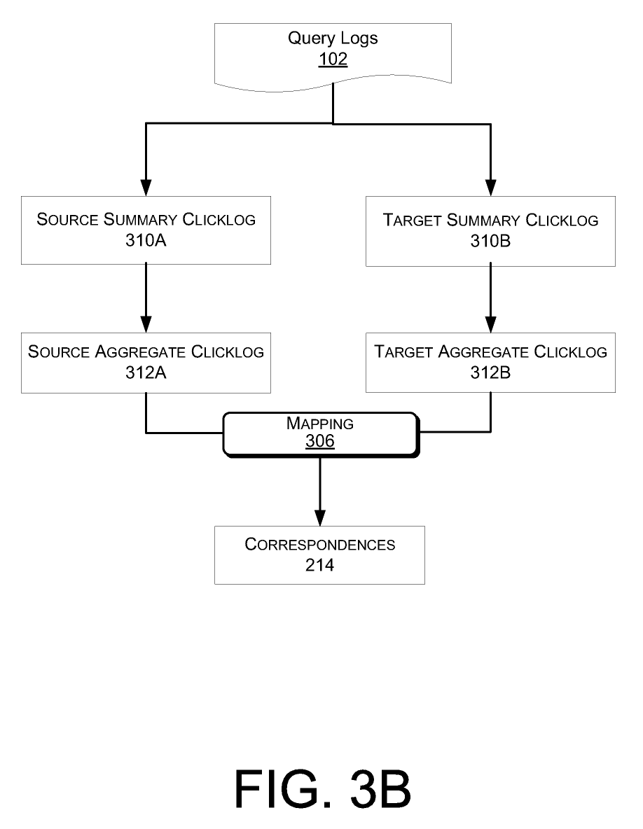

FIGS. 3A-B illustrate illustrative schema and taxonomy matching methods, according to certain embodiments.

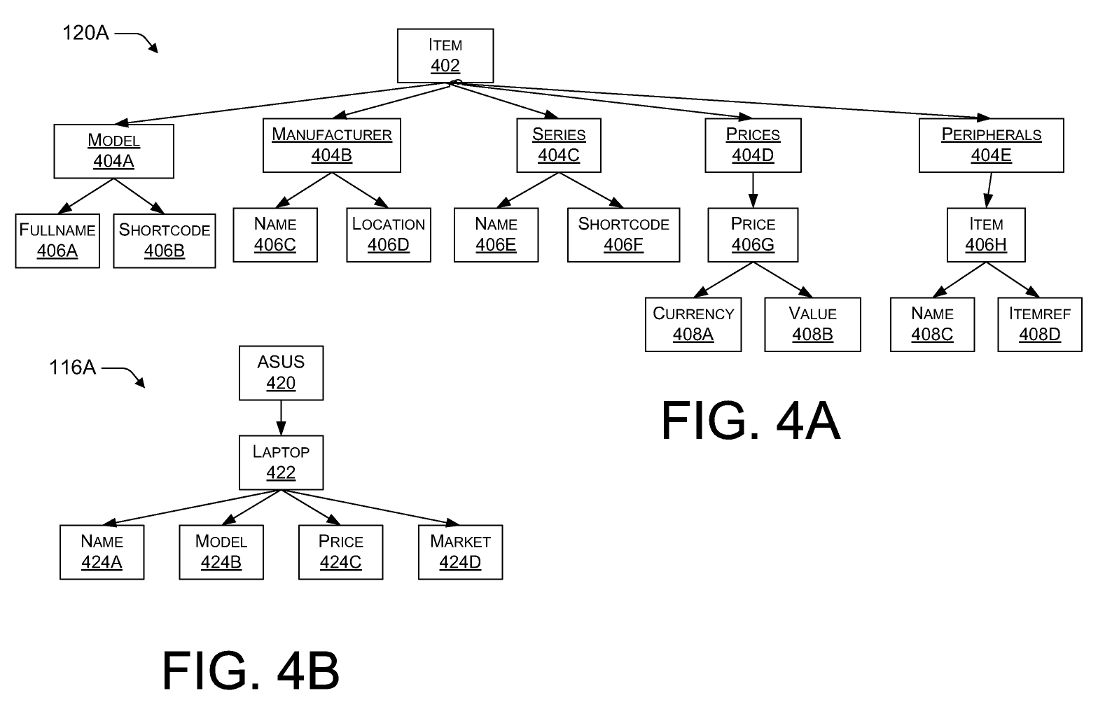

FIGS. 4A-B illustrate illustrative target and source schema, respectively, according to certain embodiments.

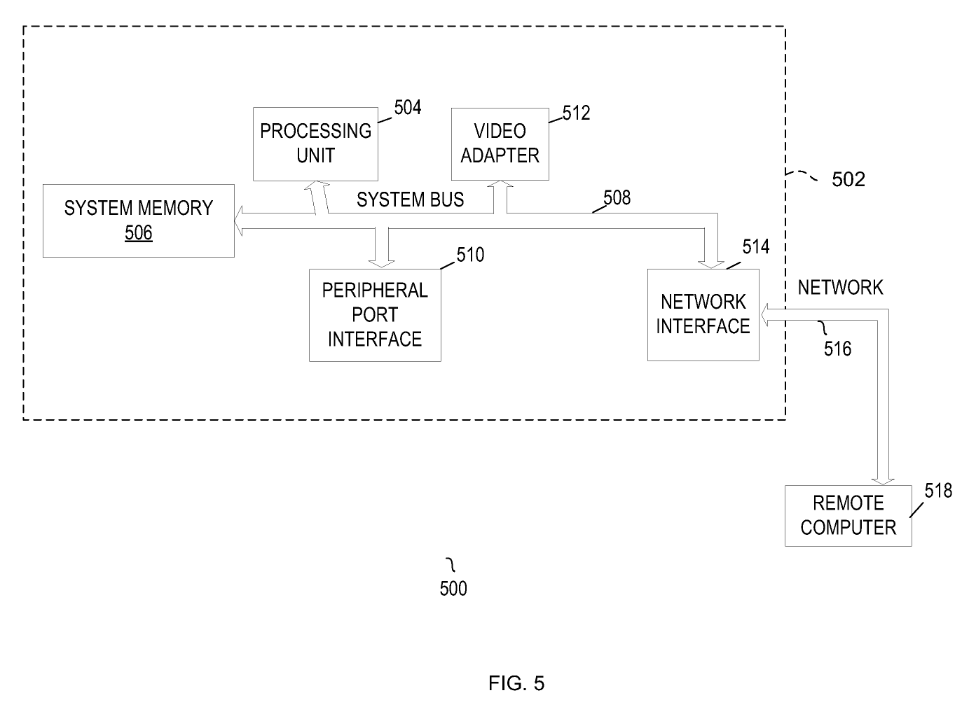

FIG. 5 illustrates one possible environment in which the systems and methods described herein may be employed, according to certain embodiments.

While the invention may be modified, specific embodiments are shown and explained by way of example in the drawings. The drawings and detailed description are not intended to limit the invention to the particular form disclosed, and instead the intent is to cover all modifications, equivalents, and alternatives falling within the spirit and scope of the present invention as defined by the claims.

### DETAILED DESCRIPTION

This document describes a system and a method for a schema and taxonomy matching process that uses click-through logs (also referred to herein as “clicklogs”) for matching source data to target data. The matching between the source data and the target data may match the schema/taxonomy of the source data to the schema/taxonomy of the target data to generate correspondences for respective elements of the source and target schema/taxonomy. The matching process may use query distributions in the one or more query clicklogs for the elements of the target schema/taxonomy and the source schema/taxonomy to generate correspondences where the click-through logs for the target data and the source data are most similar. The correspondence may be used to integrate the source data into a unified framework/structure that uses the target schema. As a result, the integrated source data and the target data may be searched on using the same keywords by the same search engine.

### Illustrative Flow Diagram

FIG. 1 is an illustrative block diagram illustrating various elements of a schema/taxonomy matching system 100 that uses query clicklogs 102, according to certain embodiments. A search engine 104 may access target data warehouse 106 that contains target data 106A. The search engine 104 may integrate structured source data 108A-C for later use in generating responses to user queries. In other words, the search engine 104 may integrate various databases and document collections (e.g., the source data 108A-C) into the target database (i.e., a target data warehouse 106). The integrated source data 108D and the target data 106A may be indexed to create an index 109, where the index 109 can be used to provide a unified search interface to the user to access the source data 108A-C and the target data 106A.

In certain embodiments, the search engine 104 may use an integration framework 110 to receive source data feeds 112 from third party source data providers 108 and map 114 and then integrate 115 the source data feeds 112 into the target data warehouse 106. Each of the source data 108A-C may be structured using a respective source schema collection 116, where the source schema collection 116 may be a source schema 116A or source taxonomy 116B. For each domain or “entity type,” the search engine's 104 target data warehouse 106 may use structured target data 106A using a target schema collection 120, where the target schema collection may be target schema 120A or a target taxonomy 120B. The source schema collection 116 (i.e., the source schema 116A and/or the source taxonomy 116B) for each of the source data 108A-C may be mapped to the search engine's target schema collection 120 (i.e., target schema 120A and/or taxonomy 120B).

The index 109 may be used by the search engine 104 to generate results to user queries. The index 109 may be a mapping from key values to data locations. In some embodiments, the index 109 may include a table with two columns: key and value. The index 109 for the target data warehouse 106 may use a key that is a keyword, where the keywords may be target schema 120A elements or target taxonomy 120B terms.

The method may use click-through query logs 102 that include click data extracted from the search engine 104. The query clicklogs 102 may consist of pairs of the form [keyword query, URL], where the URL corresponds to a selected (i.e., clicked) URL from results of a user's keyword query. Thus each query clicklog pair may contain a keyword query and a corresponding clicked-on URL. Thus, assuming that if two items in two databases (e.g., one database in the target data warehouse 106 and another database associated with a source data provider 108) are similar, then these two items would be searched for using similar queries. Applying this assumption to mapping 114 (e.g., generating correspondences between) the source schema 116A with the target schema 120A, in accordance with the current embodiment, yields the result that if two schema elements use similar keyword queries, then their respective schema elements should also be similar.

The integration framework 110 may be able to integrate 115 a wide variety of structured source data 108A-C, such as from one or more data provider(s) 108, and then use that integrated source data 108D in the target data warehouse 106 for generating query results. Specifically, the integration framework 110 may map 114 elements from the source schema collection 116 to the target schema collection 120 to generate one or more correspondences. The one or more correspondences may be used to integrate 115 the source data 108A-C into the integrated source data 108D that is structured in part based on the target schema collection 120.

Although most of the following discussion relates to using source and target schemas 116A and 120A, the source and/or target data 108A/106A may also be structured using a taxonomy 116B and 120B respectively. A taxonomy may be a generalization hierarchy (also known as an “is-a hierarchy”), where each term may be a specialization of a more general term. Since the source data 108A and target data 106A may be structured using different taxonomies, the source taxonomy 116B may be mapped into the corresponding target taxonomy 120B, i.e., by using the one or more correspondences. In some embodiments, the source taxonomy 116B and/or the target taxonomy 120B may be converted to the source schema 116A and/or the target schema 120A prior to the mapping 114 and/or the integrating process 115.

### FIG. 2

FIG. 2 is another illustrative block diagram illustrating various elements of a schema/taxonomy matching system 200, according to certain embodiments. A search engine may use an integration framework 110 to integrate 115 source data 108A into target data warehouse 106. As mentioned above, the source data 108A may use a source schema 116A and/or source taxonomy 116B to structure its data. A schema matcher 220 may match the source schema 116A and/or source taxonomy 116B to the target schema 120A and/or target taxonomy 120B, such as by creating 114 one or more correspondences 214 between similar schema elements in the source schema 116A and the target schema 120A. The one or more correspondences 214 may be used by the integration framework 110 to integrate 115 the source data 108A into the integrated source data 108D.

In certain embodiments, integrated source data 108D may use substantially the same schema and/or taxonomy as the target data 106A. As a result, the new target data that includes the target data 106A and the integrated source data 108D may be indexed and/or searched on, such as by using a web search engine or any other type of a search tool (e.g., an SQL search).

In certain embodiments, the integrated source data 108D may use a different schema and/or taxonomy from the target data 106A, and in this case the target data 106A may also be converted or transformed into transformed target data (not shown). Both the integrated source data 108D and the transformed target data may be integrated into a new target data (not shown) that uses a new schema and/or taxonomy. This new target data (which includes the transformed source data and the transformed target data) may be indexed and/or searched on, such as by using a web search engine or any other type of a search tool (e.g., an SQL search).

### FIG. 3

FIGS. 3A-C depict illustrative flow diagrams of a method 300 for a schema and taxonomy matching and integration process that uses click-through logs, according to certain embodiments. Although the description enclosed herein is directed to using an Internet search engine, it is possible to use the method(s) described herein for other uses, such as for integrating structured data between relational databases, among others.

As described below, certain portions of the blocks of FIGS. 3A-B may occur on-line or off-line. Specifically, certain blocks or portions of the blocks may be performed off-line in order to save processing time and/or speed-up the response of the on-line portions. It is also understood that certain acts need not be performed in the order described, and may be modified, and/or may be omitted entirely, depending on the circumstances.

The method 300 may operate to integrate and index structured source data 108A-C to populate an index 109 used for keyword-based searches by a keyword-based search engine 104. For each schema element (or taxonomy term) in the source schema collection 116, the method may identify the schema element (or taxonomy term) in the target schema collection 120 whose query distribution is most similar. The discussion herein of the method 300 is directed to matching source and target schema 116A and 120A respectively. However, as described below, the source taxonomy 116B may be mapped 114 and integrated 115 to the target schema 120A and/or taxonomy 120B either by converting the respective taxonomy to schema, or by operating on the respective taxonomy directly, without departing from the scope of the disclosure.

The method 300 may map data items in each of the source and target data 108A/106A to an aggregate class. The term “aggregate class” is used herein as either a schema element or taxonomy term. For example, the source data provider 108 of FIG. 1 may propagate a source data feed 112 that contains source data 108A structured using a structured data format, such as a relational table or an XML document. In other words, each data item in the source data 108A may be structured by an element of the source schema collection 116 (e.g. source schema 116A). Thus, each data item in the source data 108A may be mapped to an aggregate class. Similarly, since the target data 106A is also structured, each data item in the target data 106A may also be mapped to an aggregate class of a target schema collection 120 (e.g., a target schema 120A).

In FIG. 3A, in blocks 302A/B, according to certain embodiments, the method may receive source data and access target data, respectively. For example, the integration framework 110 may receive source data 108A-C from one or more data sources 108. The target data 106A may also be received and/or accessed (i.e., the target data 106A may be readily accessible and thus does not need to be received prior to being accessed) by the integration framework 110. In certain embodiments, the target data 106A may be periodically accessed, which may occur at different times than receiving the source data. As mentioned above, the received source data 108A-C may use source schema 116A to structure its data, whereas the target data 106A may use target schema 120A to structure its data, where the source schema 116A may be different from the target schema 120A.

In blocks 304A/B, according to certain embodiments, the method 300 may access the query clicklogs (e.g., query clicklogs 102 of FIG. 1) and generate summary and/or aggregate clicklogs for the one or more data elements in each of the source data 108A and target data 106A, respectively. In certain embodiments, the summary and/or aggregate clicklogs for the target data 106A may be pre-generated, e.g., they may be periodically generated off-line once a month, week, day, etc. By pre-generating the summary and/or aggregate clicklogs for the target data 106A, the method 300 can operate faster and thus be more responsive. In certain embodiments, if the source data 108A has been previously processed, (e.g., there's a mapping already generated, as explained below), then the method 300 may not perform this block for the source data 108A. More detailed description of operation of blocks 304A/B is described below with reference to FIG. 3B.

In block 306, according to certain embodiments, the method 300 may use the summary and/or aggregate clicklogs to map the elements of the source schema 116A into the target schema 120A by generating one or more correspondences 214. The method 300 may use a schema matcher 220 to generate the one or more correspondences 214, where each correspondence may be a pair mapping a schema element of the source schema 116A to a schema element of the target schema 120A. Block 306 may correspond to element 114 of previous FIGS. 1 and 2.

In some embodiments, the method 300 may generate a correspondence for each element of the summary and/or aggregate source clicklog that has a similar query distribution to an element in the summary and/or aggregate target clicklog. In certain embodiments, a Jaccard similarity, or another similarity function, may be used to calculate the similarity of the query distributions, as described in more detail below. In other embodiments, other techniques for calculating the similarity of query distributions may be used instead, or in addition to, the ones described.

In block 308, according to certain embodiments, the method 300 may use the one or more correspondences 214 to integrate the source data 108A into the target data 106A, such as by generating an integrated source data 108D. The integration 308 results in a common set of schema elements (e.g., schema tags) labeling all of the source data 108A and the target data 106A. For example, when importing data on movies, the target schema 120A may use a schema element of a “Movie-Name” to tag movie names, whereas the source data may be structured by source schema 116A that uses a schema element of a “Film-Title” to tag movie names. As a result, after integrating the source data, the movie names of the integrated source data 108D may also be tagged by the schema element of a “Movie-Name” (i.e., of the target schema 120A) in addition to the schema element of a “Film-Title,” whereas formerly they were tagged by the source schema 116A element of a “Film-Title.” Block 308 may correspond to element 115 of previous FIGS. 1 and 2.

FIG. 3B illustrates how the query clicklogs 102 may be used to generate aggregate clicklogs 312A/312B.

The query clicklog 102 may be sorted to generate a summary clicklog 310A/B of triples of the form [keyword query, frequency, URL] for the source data 108A and for the target data 106A, where the frequency may be the number of times that the [keyword, URL] pair was found in the query clicklog 102. The keywords in the summary clicklog 310A/B may include the elements of the source and target schema collection 116 and 120 respectively, e.g., the source and target schema 116A/120A and/or taxonomy 116B/120B respectively. Thus, the method 300 may associate a query distribution with each schema element and/or a taxonomy term.

Next, the elements of the source summary clicklog 310A and the target aggregate clicklog 310B may be grouped together, as described below, to generate a source aggregate clicklog 312A and a target aggregate clicklog 312B, respectively. The mapping 306 process may generate one or more correspondences 214 based on similarity between elements of the source aggregate clicklog 312A and the target aggregate clicklog 312B. The one or more correspondences 214 may be used to integrate 308 the source data 108A into the target data warehouse 106, and/or into the target data directly 106A.

Specifically, the method 300 may associate each schema element and/or taxonomy term with a set of URLs that appear in the summary clicklog 310A/310B. The method 300 may assume that each URL (of interest to this data integration task) refers to a “data item” or “entity.” The data item is the main subject of the page pointed to by the URL in question. For example, it could be a movie when integrating entertainment databases, or a product if integrating e-commerce data. When integrating a structured source of data, the web pages exposed by the source data are usually generated from a database.

Thus, it may be relatively easy to map a URL to a data item, as the URL may have a fixed structure, and it may be correspondingly easy to find the data item identity in this fixed structure. For example, for Amazon.com, each web page has the structure “http://amazon.com/db/{product number},” where “product number” may be the identity of a data item, such as “B0006HU400” (for Apple MacBook Pro).

In certain embodiments, the summary clicklog 310A/B may be transformed into an aggregate clicklog 312A/312B by using a two-step process. The first step of the aggregation is performed by associating the URL with a “data item” (as discussed above), and the second step of the aggregation is performed by associating the data item with an aggregate class.

Thus, the method 300 may transform the summary clicklog 310A/310B into an aggregate clicklog 312A/312B, where click frequencies are associated with aggregate classes instead of URLs. For each triple [keyword query, frequency, URL] of the summary clicklog 310/310B and each aggregate class with which the URL is associated, the method 300 may generate an “aggregate triple” [aggregate class, keyword query, frequency]. In each triple, the frequency is the sum of frequencies over all URLs that are associated with the aggregate class and that were clicked through for that keyword query. Since a given URL can be associated with more than one aggregate class, a triple in the summary clicklog 310A/310B can generate multiple aggregate triples.

In certain embodiments, the method 300 may group the aggregate triples by aggregate class, so that each aggregate class has an associated distribution of keyword queries that led to clicks on a URL in that class. That is, for each aggregate class the method 300 may generate one aggregate summary pair of the form [aggregate class, {[keyword query, frequency]}], where {[keyword query, frequency]} is a set of [keyword query, frequency] pairs that represents the distribution of all keyword queries that are associated with the aggregate class in the aggregate clicklog 312A/312B.

As a result, the method 300 may use the one or more correspondences 214 between the source and target schema elements to integrate 308 the source data 108A into the target data warehouse 106. As a result, the integrated source data 108D is structured by the target schema collection 120, and may be indexed and then accessed by the search engine 104, e.g., by using common search keywords.

### FIGS. 4A and 4B—Example

FIG. 4A illustrates an illustrative target schema 120A of an illustrative target data 106A, whereas FIG. 4B illustrates an illustrative source schema 116B of an illustrative incoming source data 108A. Thus, the target schema 120A and the source schema 116A represent two potentially differing ways to structure data for similar products. The methods described herein may produce one or more correspondences 214 from the schema collection 116 (i.e., source schema 116A and/or taxonomy 116B) of the incoming source data 108A to the schema collection 120 (i.e., target schema 120A and/or taxonomy 120B) of the target data 106A. The method 300 may extract a set of elements from the source schema 116A, and find the best mapping to the corresponding elements of the target schema 120A by performing a similarity function. Thus, each correspondence 214 may be a mapping of a pair of elements, one from each of the target schema 120A and the source schema 116A.

FIG. 4A illustrates the illustrative target schema 120A where an item 402 is the highest level in the target schema 120A. In this particular example, the item 402 may be categorized by a model 404A, manufacturer 404B, series 404C, prices 404D, and/or peripherals 404E. The model 404A (of the item 402) may be categorized by a fullname 406A or a shortcode 406B. The manufacturer 404B (of the item 402) may be categorized by name 406C and/or location 406D. The series 404C (of the item 402) may be categorized by a name 406E and/or a shortcode 406E. The prices 404D (of the item 402) may be categorized by a price 406G, which can be further categorized by currency 408A and/or value 408B. The peripherals 404E (of the item 402) may be categorized by an item 406H, which can be further categorized by name 408C and itemref 408D.

FIG. 4B illustrates the illustrative source schema 116A where “ASUS” 420 is the highest level in the source schema 116A. The “ASUS” 420 may be categorized by laptop 422, which can be further categorized by name 424A, model 424B, price 424C, and market 424D. As described, the method 300 may operate to map the elements of the source schema 116A with the elements of the target schema 120A.

As FIGS. 4A and 4B illustrate, a model element 424B on a first illustrative website using the source schema 116A may receive similar search queries as web pages on a second illustrative website that uses the target schema 120A with differing schema elements. Since each schema 120A and 116A is used to categorize similar data, schema elements of the source schema 116A may correspond to schema elements of the target schema 120A. For instance, the “model” element 424B of the source schema 116A might correspond to the “series” element 404C of the target schema 120A.

More specifically, the following example illustrates how an “eee pc” category from the source website using source schema 116A may be mapped to a “mininote” category in target schema 120A since both categories may receive illustrative queries of a “netbook.” Thus, even if there are differences in the context, domain and application between the source and the target websites, elements of the source schema 116A may be mapped 306 to elements of the target schema 120A if they are queried upon by the users in the same way.

For example, in a domain associated with laptops a query for “netbook” may return a list of small ultraportable laptops from the product inventories of all hardware manufacturers. This may require integrating 308 source data 108A-C from a large number of disparate sources 108 into an integrated source data 108D. The integrated source data 108D and the target data 106A may then be indexed into a unified index 109 for the target data warehouse 106 used by the search engine 104.

The search engine 104 may allow its users to search for laptops by providing them with integrated search results for each model of laptop, displaying technical specifications, as well as reviews and price information as gathered from a number of different source data. The source data 108A-C may range from manufacturers, to web services that aggregate model information across companies, online storefronts, price comparison services and review websites. Despite their differences, the data streams from the source data 108A-C (corresponding to various websites) may pertain to the same information, and may be combinable into the integrated source data 108D and then indexed into the index 109.

Each of the illustrative source data 108A-C may use a different source schema 116A for the computer items domain, e.g., using some and different schema elements of “manufacturer” 404B, “laptop,” “series” 404C, “peripheral” 404E, and “prices” 404D, among others. Also, even if the source data 108A-C use similar schema among themselves, they may not include some corresponding schema elements, and thus may contain different data. For example, some manufacturers may have only one line of laptops, and thus may not provide any series data. Also, other companies may use a different schema for the same naming patterns for their laptops, e.g., schema elements of subnotebooks, netbooks, and ultraportables may all refer to laptops under 3 lbs in weight. There may be no single consistent schema/taxonomy across the numerous sources of source data 108A-C, and thus the value in the fields (e.g., elements 424A-D) may be mapped as well. Furthermore, a manufacturer may have a large amount of its data in a foreign language (i.e., other than English), while the reviews for its products may use English.

Click-through data from the click-through query clicklogs 102 may be used to help mapping the schema for the source data 108A-C to the target schema. As a result, the method 300 may create summary clicklogs 310A/B that may contain three useful pieces of information, including the queries issued by the users, the URLs of the query results which the users clicked upon after issuing the query, and the frequency of such events. An illustrative summary clicklog 310A/B is shown in Table 1 for keyword queries of “netbook,” “laptop,” and “cheap netbook.”

TABLE 1

| Query | Frequency | URL |
|---|---|---|
| Laptop | 70 | http://searchengine.com/product/macbookpro |
| Laptop | 25 | http://searchengine.com/product/mininote |
| laptop | 5 | http://asus.com/eepc |
| Netbook | 5 | http://searchengine.com/product/macbookpro |
| Netbook | 20 | http://searchengine.com/product/mininote |
| Netbook | 15 | http://asus.com/eepc |
| Cheap | 5 | http://asus.com/eepc |
| Netbook | | |

For example, a user looking for small laptops may issue a query of “netbook,” and then may click on the results for “eepc” and “mininote.” In accordance with various embodiments, the action of the user clicking on these two links establishes that the two elements are related. Hence, even though the “eee pc” is considered its own product category (see element 422 of FIG. 4B) in the source schema 116A by the source data provider 108, it may be mapped to the “hp mininote” category in the target schema 120A, because the respective items from both companies were clicked on when searching for “netbooks,” “under 10” laptops” and “sub notebooks.” Also, if one were to consider all the queries that led to categories from each source, there may be an overlap between the queries of similar categories. Thus, query distributions (histograms of all queries leading to each data item and class) may be used in the integration process to identify schema elements from different data sources 108A-C which correspond to each other.

Query clicklogs 102 present a unique advantage as a similarity metric: they are generated by users, and are hence independent of the data provider's naming conventions with respect to schema and taxonomy. In addition, query information in the clicklogs 102 may be self-updating over time as the users automatically enrich the query clicklog data with new and diverse lexicons, such as capturing various colloquialisms. Thus, instead of manually updating the search engine's 104 schema 120A/taxonomy 120B to reflect that the term “netbooks” means the same thing as the term “sub notebooks,” this updating of the clicklogs 102 may be performed automatically. Additionally, clicklogs 102 provide a wealth of information for a wide variety of topics, such as user interest in a domain. Furthermore, query clicklogs 102 may be more resilient to spamming attacks, as they may not be tricked by mislabeled schema elements of incoming source data feeds 112.

### Combining Schema and Taxonomies

In certain embodiments, if the source data 108A is structured using a source taxonomy 116B, the source data may be re-arranged according to a source schema 116A. A taxonomy may be thought of as controlled vocabulary that appears in instances of a categorical attribute. For example, the source data 108A may be organized by a source taxonomy 116B for classifying data for movie genres and roles. In a movie database, a categorical attribute might be “role” with values such as “actor/star,” “actor/co-star,” “director,” and/or “author.” The range of values for the attribute “role” is an example of a taxonomy.

Taxonomies related to the same or a similar subject can be organized in different ways. For instance, a majority or entirety of the taxonomy elements may be matched, and not simply the finest grained element. For example, a computer catalog might have taxonomy values such as “computer/portable/economy” while another taxonomy may use values of “computer/notebook/professional/basic” that roughly corresponds to the former value. In this case, the entire paths for the taxonomies may be matched, not simply the terms “economy” and “basic.”

When mapping 306 taxonomies that appear in the source data 108A, the method 300 may transform the taxonomy values into schema elements. For example, instead of a taxonomy element of “role” with “actor/star” as a data value, the method 300 may use “role/actor/star” as a hierarchical schema element (e.g., in XML) with a data value being the data item that was associated with the role, such as “Harrison Ford.” This transformation of a data value into a schema element (or vice versa) is called a “pivot” in some spreadsheet applications as well as elsewhere. In this case, after applying the pivot, the method 300 may treat the mapping 306 of taxonomy values as the mapping 306 of schema elements.

As mentioned, both taxonomies and schema 116 from the source data (e.g., 108A-C of FIG. 1) may be matched to the target data 106A's taxonomy and/or schema. The above description is in part directed to matching the source schema 116A with the target schema 120A. However, in certain embodiments, for source data 108A that uses taxonomies, the respective source taxonomy 116B and/or the target taxonomy 120B may be first converted to source schema 116A and target schema 120B respectively. In other embodiments the method 300 may operate on the source taxonomy 116B and the target taxonomy 120B directly, without this conversion.

In certain embodiments, the source data may use XML format, and the target warehouse 106 may use a collection of XML data items. However, this is illustrative only, and the methods described herein may be easily used with other formats in addition to, or instead of, the XML format. Since XML data can be represented as a tree, the method 300 may perform schema mapping as mapping between nodes in two trees, the one representing the data feed's XML structure and the one representing the warehouse schema. However, other data structures may be used in addition to, or instead of, the tree data structure.

The mapping process may involve extracting a set of features from the structure and content of the XML data, and then use a set of similarity metrics to identify the most appropriate correspondences from the tree representing the source schema 116A to the tree representing the target schema 120A. An illustrative XML feed (e.g., part of a source data feed 112) containing an illustrative source taxonomy 116B is shown below:

<feed>
<laptop>
<name>ASUS eeePC</name>
<class>Portables | Economy | Smallsize</class>
<market>Americas | USA</market>
</laptop>
</feed>

For the schema mapping task, the words “ASUS” and “eeePC” may be considered as features for the schema element of “name.” In certain embodiments, when using value-based schema mapping 306, the target schema 120A element whose instances contained mentions of “ASUS” would most likely be an ideal schema match for “name.”

In certain embodiments, since the source taxonomy 116B and the target taxonomy 120B are not necessarily identical, the method 300 may perform a tree mapping/conversion operation for these taxonomies. In certain embodiments, this conversion may use a pivot operation that converts the categorical part of each XML element (that uses a taxonomy) into its own mock XML schema, including other fields as needed. For the above example, the pivot operation may be first performed on the categorical field “class,” keeping “name” as a feature. This converts the above XML taxonomy feed into the following XML schema feed:

<feed>
<laptop>
<Portables>
<Economy>
<Smallsize>ASUS eeePC</Smallsize>
</Economy>
</Portables>
<laptop>
</feed>

Thus, for a stream of data items in XML format with a set of aggregate classes, the method 300 may construct a mapping between a set of aggregate classes for the target schema 120A and for the source schema 116A. However, in some embodiments, the method 300 may directly operate on elements structured using a taxonomy, without converting to the schema structure. Furthermore, if the method 300 uses a tree structure for each data item feed, the above mapping may only be performed for the leaf nodes of each tree structure. In certain embodiments, other data structures may be used instead of, or in addition to, the tree data structures described above.

### Clicklogs

As described above, the method 300 may use the information available in the search engine's 104 query clicklogs 102, although the clicklogs 102 may be external to the search engine 104 as well. Specifically, the method 300 may use a summary clicklog 310A/B, which may summarize all the instances in the query clicklogs 102 when a user has clicked on a URL for a search result. Each entry of the summary clicklog 310A/B may comprise the search query, the URL of the search result, and the number of times that URL was clicked for that search query. For example, a summary clicklog 310A/B entry of a <laptop, 5, http://asus.com/eeepc> indicates that for the query “laptop,” the search result with URL http://asus.com/eeepc was clicked 5 times. All other information (such as unique identifiers for the user and the search session) may be discarded to safeguard the privacy of at least those users wishing to maintain their privacy. Indeed, some illustrative embodiments allow users to opt into, or out of, having their clicks available for such processing. Given this clicklog data, the method 300 may extract the entries for each data item and may use them for data integration purposes, e.g., to generate a query distribution of each data item.

An aggregate clicklog 312A/B may use a query distribution of a data item using aggregate classes. An aggregate class is a set of data items that may be defined by a schema element or a taxonomy term. Aggregate classes may be groups of instances, e.g. instances of the same schema element, such as “all the Name values in a table,” or instances belonging to the same category, such as “all items under the category netbook.” An aggregate class may be defined by a schema element and may include all the data items that can be instances of that schema element. For example, the aggregate class of “<Review>” (as defined by the target schema 120A) may include the reviews of all target data items in the target data 106A. Similarly, an aggregate class that is defined by a taxonomy term may include all data items covered by that taxonomy term. For example, the aggregate class defined by the taxonomy term “Computers Laptop.Small Laptops” may include the entities “MiniNote” and/or “eepc.”

The query distribution of aggregate classes may use a normalized frequency distribution of keyword queries that may result in the selection of an instance as a desired item in a database search task. For example, according to the summary clicklogs 310A/B of Table 1, of the 25 queries that led to the click of the database item “eeePC” (denoted by http://asus.com/eeepc), five were for “laptop,” 15 for “netbook” and the remaining five for “cheap netbook.” Hence, after normalization of the above example, the query distribution may be {“laptop”:0.2, “netbook”:0.6, “cheap netbook”: 0.2}.

The query distribution for an aggregate class, in the current illustrative embodiment, may be the normalized frequency distribution of keyword queries that resulted in a selection of any of the member instances. Illustrative query distributions for three aggregate classes are shown in Table 2.

TABLE 2

| Aggregate class/category | Query Distribution |
|---|---|
| Warehouse: “ . . . Small Laptops” | {“laptop”: 25/45, |
| | “netbook”: 20/45} |
| Warehouse: “ . . . Professional Use” | {“laptop”: 70/70} |
| Asus.com: “eee” | {“laptop”:5/25, |
| | “netbook”:15/25, |
| | “cheap netbook”:5/25} |

To generate query distributions for data items using the summary clicklogs 310A/B (e.g., as shown in Table 1), in certain embodiments, the method 300 may assume that a search result URL can be translated into a reference to a unique database item. However, many websites may be database driven, and thus may contain unique key values in the URL itself. For example, some websites, such as Amazon.com, may use a unique “ASIN number” to identify each product in their inventory. The ASIN number may also appear as a part of each product page URL.

For example, a URL of “http://amazon.com/dp/B0006HU400” may be directed to a product with the ASIN number of B0006HU400 (which may identify the Apple Macbook Pro laptop). As a result, for the example above, the “macbookpro” and “mininote” may be used as primary keys to identify the corresponding items in the database. Hence, to generate the query distribution for product items from some websites (such as Amazon.com), the method 300 may simply look up the product item's ASIN number, and then scan the clicklogs 102 for entries with URLs that contain this ASIN number. As a result, the method 300 may generate a frequency distribution of keyword queries for each product item.

In certain embodiments, to ensure that query distributions may be used as features in the integration process, some similarity measures may be used, including:
The query distributions of similar entities are similar (e.g., if illustrative Toshiba m500 and Toshiba x60 data items are similar items, then the query distributions for the Toshiba m500 and Toshiba x60 data items are similar as well);
Query distributions of similar aggregate classes are similar; and
The query distribution of a database item is most similar to its own aggregate class in order to use query distributions for classification purposes.

### Mapping

The query distributions may be then used to generate the one or more correspondences 214 by the mapping process 306. A comparison metric, such as Jaccard similarity, may be used to compare two query distributions (e.g., query distribution of queries in the source schema collection 116 and of the target schema collection 120). However, other comparison metrics may be used in addition to, or instead of, the Jaccard similarity. Thus, given an incoming third party database (e.g., one of the source data 108A-C), the method 300 may generate a mapping (e.g., one or more correspondences 214) between the aggregate classes of the source schema 116A and the target schema 120A. Similarity scores above a threshold may be considered to be valid candidates for the one or more correspondences 214. In certain embodiments, this threshold may be automatically generated by the integration framework 110, and/or it may be manually set by the user.

For example, the target data warehouse 106 may contain one HP Mininote small laptop product item, with the category “Computers.Laptop.Small Laptops,” as well as an “Apple Macbook Pro” item as the only laptop in the “Computers.Laptop.Professional Use” category. If a third party laptop manufacturer (e.g., Asus, a source data provider 108) wants to include its data in the target data index 109, then it may upload its source data 108A-C as an XML feed to the search engine 104 (structured either using a source or target schema, as described above). An illustrative source data item “eee PC” in the source data 108A may be assigned to the category “eee” in the source taxonomy 116B. The method 300 may then map the source schema 116A “eee” category to the appropriate target schema 120A category.

In the above example, the mapping process 306 may generate two query distributions for the aggregate classes representing each of the two target schema 120A categories, and then compare them with the query distribution for the aggregate class representing the source schema 116A (e.g., from ASUS) category “eee.” In this example, the method 300 may analyze the summary clicklogs 310A/B and/or aggregate clicklogs 312A/B, and observe that 100 people have searched (and clicked a result) for the word “laptop;” 70 of whom clicked on the Apple Macbook Pro item, 25 on the HP MiniNote item, and 5 on the link for the Asus “eee PC” item in the incoming source feed 112. Furthermore, for the query “netbook,” there may be 40 queries, 5 of which have clicked-through on Macbook, 20 on the MiniNote product, and 15 on the eee PC. For the query “cheap netbook,” 5 out of 5 queries resulted in clicks to eeePC. The method 300 may count both the number of clicks to the items in the target data 106A (such as the Apple Macbook Pro), and also the clicks to the third party items from the source data 108A, thus also indexing the third party (e.g., Asus) web site.

In addition, the method 300 maps 306 the product pages on third party's web site (e.g., asus.com) to data items of the source data 108A feed, since each source page URL may be constructed using a primary key for the source data item. If a user clicks on a result from the third party's website, that click may be translated to the corresponding third party's item. Hence, the illustrative query distribution for the aggregate class representing the source schema 116A “eee” category may be {“laptop”:5, “netbook”:15, “cheap netbook”:5}. For the aggregate class representing the target schema 120A of “Computers.Laptop.Small Laptops” category, the illustrative distribution may be {“laptop”:25, “netbook”:20}, and for “Computers.Laptop.Professional Use,” the illustrative query distribution is {“laptop”:70}.

After preprocessing the summary clicklogs 310A/B to generate query distributions of the aggregate classes to generate aggregate clicklogs 312A/BB, the method 300 may compare and map each pair as follows:

Compare-Distributions(Distribution DH, Distribution DF)

1 score = 0
2 for each query qh in DH
3 do {for each query qf in DF
4 do {minFreq = Min(DH[qh],DF [qf ])
5 score = score + Jaccard(qh, qf ) × minFreq}}
6 return score

Where Jaccard similarity is defined as:

$$Jaccard = \frac{\vert Words ( q 1 ) ⋂ Words ( q 2 ) \vert}{\vert Words ( q 1 ) ⋃ Words ( q 2 ) \vert}$$

For example, the method 300 may use the query distributions in Table 2 to map the aggregate classes of the source data 108A-C category “eee” {laptop:0.2, netbook:0.6, “cheap netbook”:0.2} to the target data 106A category “Small Laptops” {“laptop”:0.56, “netbook”:0.44}. Comparing each combination of the query distribution, an illustrative score for the above mapping may be (1×0.2+1×0.44+0.5×0.2)=0.74. On the other hand, the score for comparing the “eee” element of the source schema 116A with the target schema 120A category of “Professional Use” may be (1×0.2)=0.2, which is smaller than the similarity score for the previous mapping. As a result, the illustrative “Computers.Laptop.Small Laptops” correspondence 214 is generated 306 for the source schema 116A category of “eee.”

In certain embodiments, different functions may be used in addition to, or instead of, the Jaccard similarity, including a unit function (e.g., a Min variant) or the WordDistance function:

WordDistance(n)=Len(Words(q1)∩Words(q2))ⁿ

Each similarity function may be chosen for different reasons. For example, the Jaccard similarity may compensate for large common search keywords, as it may examine the ratio of common vs. uncommon keywords. The WordDistance similarity function may allow exponential biasing of overlaps, e.g., by considering the length of the common words. An exact string similarity function (i.e., the Min variant) may also be used for counting queries that are identical in both the source and target distributions. The Min variant similarity function may be used for quick analysis, as it may not perform word-level text analysis.

In certain embodiments, the clicklogs 102 may be combined from multiple third party search engines, ISPs and toolbar log data, where the only information may be the user's acknowledgement that the search result is relevant for the particular query. As a result, the clicklogs 102 may capture a lot more information than may be provided by the search engine's 104 relevance ranking.

### Finding Surrogates

In order to facilitate the use of the query distributions, the method may use source data 108A-C that have a web presence. By having a web presence (e.g., a significant web presence), click-through logs 102 may be generated for each of the source data 108A-C, i.e., because they are popular and have sufficient click-through data. This might not be the case for some source data providers. However, even these less popular data providers may have competitors with similar data. If these competitors have a significant web presence, their corresponding clicklogs 102 may be used instead.

This alternate source data can have enough entries in the clicklog to be statistically significant. For each source data element in the source data feed 112 for the less popular data provider, the method 300 may identify a data element from another, more popular source that is most similar to the source data element. The more popular data source may have enough query volume to generate a statistically significant query distribution. The data item of the more popular data source may be called a “surrogate data item.” A variety of similarity measures could be used to find surrogate data items, such as string similarity.

By identifying and using surrogate clicklogs, the method 300 may perform schema mapping 306 for the source data 108A-C without a significant web presence. For each candidate data item with source data 108A without a significant web presence (e.g., there is little if any corresponding clicklogs), the method 300 may look for a surrogate clicklog. The surrogate clicklog may be found by looking for a data item(s) in data feeds already processed by the integration framework 110 that are most similar to the data element(s) in the source data. The method 300 may use that surrogate clicklog data to generate a query distribution for the data element(s) in the source data. An example pseudo-code is shown below:

Get-Surrogate-ClickLog(Entity e)

1 query = DB-String(e)
2 similarItems = Similar-Search(targetDB, query)
3 surrogateUrl = similarItems[0].url
4 return Get-ClickLog(surrogateUrl)

For example, if a data feed 112 does not have a web presence (and thus doesn't have entries in the clicklog 102), the method 300 may search for a surrogate clicklog (as described above) to use as a substitute. For example, the method 300 may find a surrogate clicklog using data from Amazon.com.

Using the illustrative pseudo-code above, for an instance in the source data feed 112, the DB-String function (in the pseudo-code above) may return a concatenation of the “name” and “brandname” attributes as the query string, e.g., return item.name+“ ”+item.brandname. For the “Similar-Search” function, the illustrative pseudo-code may use a web search API (e.g., from Yahoo or another web search engine) with an illustrative “site:amazon.com inurl:/dp/” filter to find the appropriate Amazon.com product item and a URL for a given data item of the source data feed 112. As a result, the web search may only search for pages within the “amazon.com” domain that also contain “/dp/” in their URL. Using illustrative pseudo-code above, in line 4, the method 300 may simply pick the top result from the results returned by the web search, and use its URL as the corresponding surrogate URL for the given data item. Next, the search engine's clicklog may be searched for this corresponding surrogate URL to generate a surrogate clicklog for that given data item.

### Data in the Realworld

The method 300 described above can be used with various types of data model and data structuring conventions. For example, the source data 108A-C may include XML streams, tab separated values (TSV), and SQL data dumps, among others. Within each data model, the method 300 can map 306 and integrate 308 source data that uses various conventions with regards to schema and data formats, including levels of normalization, in-band signaling, variations in attributes and elements, partial data, multiple levels of detail, provenance information, domain specific attributes, different formatting choices, and use of different units, among others.

Levels of normalization: Some data providers 108 of source data 108A-C may normalize the structure of their data elements, which may result in a large number of relations/XML entity types. On the other hand, other data providers may encapsulate all their data into a single table/entity type with many optional fields.

In-band signaling: Some data providers 108 of the source data 108A-C may provide data values that contain encodings and/or special characters that may be references and lookups to various parts of their internal database. For example, a “description” field for the laptop example above may use entity names that are encoded into the text, such as “The laptop is a charm to use, and is a clear winner when compared to the $laptopid:1345$.” The field $laptopid may then be replaced with a linked reference to another laptop by the application layer of the source data provider's 108 web server.

Attributes vs. Elements: Some data providers 108 of the source data 108A-C may use XML data with variation in the use of attribute values. For example, some source data datasets may not contain any attribute values, while another dataset may have a single entity type that contains a large number of attributes. In certain embodiments, the method 300 may treat most or all such attributes as sub-elements.

Partial Data: Some data providers 108 of source data 108A-C may provide only a “cutaway” of the original data. In other words, certain parts of the database may be missing for practical or privacy purposes. In some illustrative embodiments, users may indicate whether some or all data relating to their activities should be excluded from the methods and systems disclosed herein. The integration framework 110 may be able to map the source and the target data even when there are dangling references and unusable columns in one or more of the source and target data schema collection 116 and 120 respectively.

Multiple levels of detail: Some data providers 108 of source data 108A-C may use varying levels of granularity in their data. For example, when categorizing data items, one provider may classify a laptop item as “computer,” and another may file the same laptop under “laptops.ultraportables.luxury.” The integration framework 110 may be able to process the source data in these instances, as described above, by using clicklogs 102, as described herein.

Provenance information: Some data providers 108 of source data 108A-C may provide extraneous data that may not be usable. For example, some of the provided data may include provenance and bookkeeping information, such as the cardinality of other tables in the database and the time and date of last updates. The integration framework 110 may be able to discard and/or ignore this extraneous information.

Domain specific attributes: Some data providers 108 of the source data 108A-C may use a proprietary contraction whose translation is available only in the application logic, for example “en-us” to signify a US English keyboard. The integration framework 110 may be able to process the source data in these instances, as described above, by using clicklogs, and/or by reading the context in which these domain specific attributes are used.

Formatting choices: There may be considerable variation in format between the data provided by the source data providers 108 of the source data 108A-C. This is not restricted to just date and time formats. For example, source data providers 108 may use their own formats, such as “56789:” in the “decades active” field for a person's biography, denoting that the person was alive from the 1950s to current. The integration framework 110 may be able to process the source data in these instances, as described above, by using the clicklogs 102, and/or by reading the context in which these domain specific attributes are used.

Unit conversion: Some data providers 108 of the source data 108A-C may use different interchangeable units for quantitative data, e.g., Fahrenheit or Celsius, hours or minutes. Also, the number of significant digits used by the quantitative data may vary, e.g., one source data 108A may have a value of 1.4 GHz, while another source data 108B may use 1.38 GHz. However, approximation is somewhat sensitive to semantics, e.g., it should not be applied to some standards such as referring to the IEEE standards of 802.11, 802.2 and 802.3 (as they most probably refer to networking protocols in the hardware domain). The integration framework 110 may be able to process the source data in these instances, as described above, by using the clicklogs 102, and/or by reading the context in which these domain specific attributes are used.

### Quality Measures

Certain embodiments may vary the above described methods for using clicklogs. For example, the clicklogs 102 may be indexed, which may reduce the mapping generation time. Furthermore, the actual structure of the queries themselves may be analyzed and used as an additional possible input feature for the mapping mechanism 306. Furthermore, the mapping 306 may use a confidence value to best determine that if information from the clicklog 102 is the best source of mappings for a particular schema/taxonomy element. For example, the similarity scores (e.g., obtained by using the Jaccard similarity calculation) may require a certain threshold value. Alternatively, the amount and/or quality of the clicklog 102 used in the mapping process may be examined; if it is small then it is likely that the mapping 306 is of lower quality. A quality mapping process 306 may use a large portion of the clicklog 102, as there may be sections with a large number of users whose clicks “agree” with each other, as opposed to sections with a few disagreeing users.

One possible idea is to use search satisfaction as an objective function for mapping quality. Sample testing may be used where a small fraction of the search engine users may be presented with a modified search mechanism. Various aspects of the users' behavior, such as order of clicks, session time, answers to polls/surveys, among others, may be used to measure the efficacy of the modification. While each mapping 306 usually consists of the top correspondence match for each data item, the method 300 could instead consider the top correspondences for each item, resulting in multiple possible mapping configurations. Each mapping configuration may be used, and the mapping 306 that results in the most satisfactory user experience may be picked as the final mapping answer. Of course, users may opt out of having data relating to their activities used in such manners or indeed even collected at all.

### Illustrative Computing Device

FIG. 5 illustrates one operating environment 500 in which the various systems, methods, and data structures described herein may be implemented. The illustrative operating environment 500 of FIG. 5 includes a general purpose computing device in the form of a computer 502, including a processing unit 504, a system memory 506, and a system bus 508 that operatively couples various system components. The various system components include the system memory 506 to the processing unit 504, such as a peripheral port interface 510 and/or a video adapter 512, among others. There may be only one or there may be more than one processing unit 504, such that the processor of computer 502 comprises a single central-processing unit (CPU), or a plurality of processing units, commonly referred to as a parallel processing environment. The computer 502 may be a conventional computer, a distributed computer, or any other type of computer.

The computer 502 may use a network interface 514 to operate in a networked environment by connecting via a network 516 to one or more remote computers, such as remote computer 518. The remote computer 518 may be another computer, a server, a router, a network PC, a client, a peer device or other common network node, and typically includes many or all of the elements described above relative to the computer 502. The network 516 depicted in FIG. 5 includes the Internet, a local-area network (LAN), and a wide-area network, among others. Such networking environments are commonplace in office networks, enterprise-wide computer networks, intranets and the Internal, which are all types of networks. In a networked environment, the various systems, methods, and data structures described herein, or portions thereof, may be implemented, stored and/or executed on the remote computer 518. It is appreciated that the network connections shown are illustrative and other means of and communications devices for establishing a communications link between the computers may be used.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method implemented on a computing device by a processor configured to execute instructions that, when executed by the processor, direct the computing device to perform acts comprising:
receiving source data comprising a plurality of source data items structured using a source schema collection;
accessing target data comprising a plurality of target data items structured using a target schema collection;
analyzing one or more query clicklogs for distribution of queries for elements of the source schema collection to generate a source summary clicklog;
analyzing the one or more query clicklogs for distribution of queries for elements of the target schema collection to generate a target summary clicklog; and
generating one or more correspondences between the source schema collection and the target schema collection using the source summary clicklog and the target summary clicklog.

2. The method of claim 1, wherein the distribution of queries for elements of the source schema collection comprises click-through frequency and corresponding URLs for the elements of the source schema collection; and
wherein the distribution of queries for elements of the target schema collection comprises click-through frequency and corresponding URLs for the elements of the target schema collection.

3. The method of claim 1, wherein said analyzing one or more query clicklogs for distribution of queries for elements of the source schema collection comprises determining a frequency distribution indicating the number of times that one or more keyword queries lead to a click on a corresponding URL.

4. The method of claim 1, further comprising:
integrating the source data with the target data using the one or more correspondences.

5. The method of claim 1, wherein said generating the schema correspondence comprises:
grouping the source click-through data into a source aggregate summary clicklog; and
grouping the target click-through data into a target aggregate summary clicklog;
wherein the one or more correspondences are determined by calculating a similarity between elements of the source aggregate summary clicklog and the target aggregate summary clicklog.

6. The method of claim 5, further comprising:
applying a confidence value determination to the one or more correspondences, wherein each of the one or more correspondences are generated if the similarity between elements of the source aggregate summary clicklog and the target aggregate summary clicklog meets the confidence value.

7. The method of claim 1, further comprising:
wherein the source schema collection comprises one or more of a source schema and a source taxonomy; and
wherein the target schema collection comprises one or more of a target schema and a target taxonomy.

8. The method of claim 7, further comprising:
if the source schema collection comprises the source taxonomy, converting the plurality of source items structured using the source taxonomy to the plurality of source items structured using the source schema; and
if the target schema collection comprises the target taxonomy, converting the plurality of target items structured using the target taxonomy to the plurality of target items structured using the target schema.

9. The method of claim 1, wherein said analyzing the one or more query clicklogs for distribution of queries for elements of the source schema collection comprises using one or more surrogate query clicklogs.

10. The method of claim 1, further comprising:
integrating the source data into the target data by converting the source data using the one or more correspondences such that the source data is structured using the target schema collection in response to said integrating.

11. A method implemented on a computing device by a processor configured to execute instructions that, when executed by the processor, direct the computing device to perform acts comprising:
analyzing a query clicklog to generate a target summary clicklog for target data, wherein the target data is organized using a target taxonomy;
analyzing the query clicklog to generate a source summary clicklog for source data, wherein the source data is organized using a source taxonomy; and
mapping the source taxonomy to the target taxonomy using the source summary clicklog and the target summary clicklog to generate one or more correspondences between the source taxonomy and the target taxonomy.

12. The method of claim 11, wherein said mapping the source taxonomy to the target taxonomy comprises:
grouping the source summary clicklog into a source aggregate summary clicklog by grouping together similar elements in the source taxonomy;
grouping the target summary clicklog into a target aggregate summary clicklog by grouping together similar elements in the target taxonomy; and
generating the one or more correspondences between the source taxonomy and the target taxonomy using the aggregate source summary clicklog and the aggregate target summary clicklog.

13. The method of claim 12, wherein the one or more correspondences are determined from calculating similarities between elements of the source aggregate summary clicklog and the target aggregate summary clicklog.

14. The method of claim 11, further comprising:
converting the source data into converted source data using the results of said mapping; and
integrating the converted source data into the target data.

15. A tangible computer readable medium having computer-executable modules comprising:
an integration framework module operable to:
using a first click-through log, generate click-through frequencies for elements of a target schema, wherein the target schema is used to structure one or more target data items; and
using a second click-through log, generate click-through frequencies for elements of a source schema, wherein the source schema is used to structure one or more source data items; and
a mapping module in communication with the integration framework module and operable to use the click-through frequencies for the target schema and the click-through frequencies for the source schema to:
map the click-through frequencies between the source schema and the target schema to generate one or more correspondences.

16. The tangible computer readable medium of claim 15, wherein the first click-through log and the second click-through log are the same.

17. The tangible computer readable medium of claim 15, wherein if there is not enough data in the first click-through log to said generate the click-through frequencies for the source schema,
the integration framework module is operable to use a surrogate click-through log instead of the first click-through log.

18. The tangible computer readable medium of claim 15, wherein the mapping of the click-through frequencies further comprises:
grouping the click-through frequencies for the elements of the source schema to generate a source aggregate summary clicklog by grouping together similar elements of the source schema;
grouping the click-through frequencies for the elements of the target schema to generate a target aggregate summary clicklog by grouping together similar elements of the source schema; and
prior to said mapping, generating the one or more correspondences between the source schema and the target schema using the aggregate source summary clicklog and the aggregate target summary clicklog.

19. The tangible computer readable medium of claim 18, wherein the one or more correspondences are determined from calculating a similarity between elements of the source aggregate summary clicklog and the target aggregate summary clicklog.

20. The tangible computer readable medium of claim 15, wherein the integration framework module is further operable to:
integrate the source data items with the target source data items into an integrated source data using the integrated source schema.
